(19) United States
(12) Patent Application Publication
(10) Pub. No.: US 2011/0146643 A1
(43) Pub. Date: Jun. 23, 2011

(54) Two-Stroke Engine

(75) Inventors: Werner Geyer, Berglen (DE); Helmut Zimmermann, Berglen (DE); Martin Leiendecker, Goppingen (DE)

(73) Assignee: ANDREAS STIHL AG & CO. KG, Waiblingen (DE)

(21) Appl. No.: 12/968,309

(22) Filed: Dec. 15, 2010

(30) Foreign Application Priority Data
Dec. 19, 2009 (DE) 10 2009 059 144.3

(51) Int. Cl. F02B 33/04

(52) U.S. Cl. 123/73 PP

(57) ABSTRACT

A two-stroke engine has a cylinder with a combustion chamber and a piston reciprocatingly supported in the cylinder. A crankshaft is rotatably supported in a crankcase and driven by the piston. At least one transfer passage connects the crankcase in at least one position of the piston with the combustion chamber and has a piston-controlled transfer port that opens into the combustion chamber and an opening that opens into the crankcase. A mixture inlet opens into the crankcase. An outlet is provided at the combustion chamber. The transfer port and the opening are displaced relative to each other in a circumferential direction of the cylinder. At least one wall section of the transfer passage forms an undercut when viewed from the crankcase in a direction of a longitudinal cylinder axis of the cylinder and is delimited by a separate component inserted into the cylinder from a side facing the crankcase.

### BACKGROUND OF THE INVENTION

The invention concerns a two-stroke engine with a cylinder and with a combustion chamber disposed therein that is delimited by a piston reciprocatingly supported in the cylinder, wherein the piston drives a crankshaft that is rotatably supported in a crankcase, wherein the crankcase in at least one position of the piston is connected through at least one transfer passage with the combustion chamber, wherein the transfer passage opens by means of a piston-controlled transfer port into the combustion chamber and by means of an opening into the crankcase, wherein the two-stroke engine has a mixture inlet into the crankcase and an outlet from the combustion chamber, wherein the transfer port and the opening of the transfer passage are displaced relative to each other in the circumferential direction of the cylinder, wherein at least one wall section of the transfer passage forms an undercut when viewed from the crankcase in the direction of the longitudinal cylinder axis.

In AT 39 34 09 B a cast cylinder is disclosed for two-stroke internal combustion engines. The cylinder has transfer passages arranged in a cylinder wall; the transfer passages consist of a segment that extends from the crankcase in the longitudinal cylinder direction, a curved transition, and a transverse segment that opens into the cylinder. The cylinder consists of two fixedly connected coaxially engaging parts. Both cylinder parts are produced by a pressure die casting process and have in the area of the openings of the transfer passages an abutment surface that essentially extends transversely to the cylinder axis. Adjoining this area, both cylinder parts have piston bearing surfaces extending toward the cylinder head and toward the crankshaft.

From U.S. Pat. No. 7,694,658 a two-stroke engine is known that encompasses a piston that is reciprocatingly moveable in a cylinder liner. The piston delimits upwardly a combustion chamber and is connected in downward direction by a connecting rod with a crankshaft that is rotatably supported in a crankcase below the cylinder liner.

It is the object of the present invention to provide a two-stroke engine of the aforementioned kind which is to be produced with a simple tool (mold) and is thus cheaper to produce.

### SUMMARY OF THE INVENTION

This object is solved by a two-stroke internal combustion engine (in the following two-stroke engine) of the aforementioned kind wherein the wall section is delimited by a separate component that is inserted into the cylinder from a side that is facing the crankcase.

Since a wall segment of the transfer passage is delimited by a separate component that is inserted from the side facing the crankcase into the cylinder, it is possible in a simple way to form an undercut of the transfer passage geometry. The cylinder can therefore still be produced, since the wall forming the undercut is a separate component, by pressure die casting with pullable cores (pull cores). Lost cores are not necessary so that the manufacture of the cylinder remains simple. It has been found that the displacement of the opening and transfer port relative to one another in the circumferential direction of the cylinder provides clearly improved exhaust gas values as a result of better combustion chamber scavenging. Moreover, a small size of the two-stroke engine results. As a result of the insert it is also possible to realize different flow-through cross-sections in the transfer passages by using different separate components. A standardized cylinder can thus be used for engines with different engine power.

The separate component is in particular a cylinder liner. The cylinder liner forms on its inner circumference at least one segment of the piston bearing surface of the cylinder. In this connection, the cylinder liner does not extend in particular about the entire height of the cylinder but from the side of the cylinder facing the crankcase to approximately the level of the transfer port. In this connection, the cylinder liner may end at the lower edge of at least one of the transfer ports or may delimit the side walls of the transfer ports partially or completely. It is provided that in the wall of the cylinder liner at least one channel is formed, wherein a transfer passage extends in the at least one channel and the at least one channel delimits at least one side wall of the transfer passage. Advantageously, several channels are formed in the wall of the cylinder liner. In particular all transfer passages extend in channels of the cylinder liner. Since the channels are formed in the wall of the cylinder liner, the cylinder liner can also be simply produced by pressure die casting. In this connection, the channels are formed in particular as radially outwardly open grooves in the wall of the cylinder liner and are sealed by the cylinder wall in the outward direction. The cylinder bore can thus be embodied to be smooth. Therefore, the side walls of the transfer passages that extend in circumferential direction are embodied advantageously completely within the cylinder liner across the entire height of the cylinder liner.

Advantageously, a segment of at least one transfer passage is formed by a depression in the cylinder bore that forms the transfer port at the end of the transfer passage facing the combustion chamber. In this area, the transfer passages extend advantageously parallel to the longitudinal cylinder axis so that the depressions can be simply molded by pressure die casting. It is provided that the cylinder liner has a sleeve body and a sleeve segment with reduced diameter, wherein the sleeve segment seals the depression in a radial inward direction. The depressions that end above the sleeve segment in the combustion chamber form the transfer ports which are piston-controlled.

In order to achieve a weight reduction of the two-stroke engine in a simple way, it is provided that the cylinder liner has at least one depression that is sealed completely by the cylinder. In this connection, the depression is a depression in the wall of the cylinder liner that does not communicate with the interior. After the installation of the cylinder liner the depression is sealed completely by the cylinder and forms thus an air-filled cavity that reduces the weight of the two-stroke engine.

The cylinder liner is in particular a pressure die-cast part. The wall surface of the cylinder liner is expediently fine-machined, in particular fine-turned. The cylinder liner is advantageously pressed into the cylinder bore. As a result of fine-machining, a tight seat of the cylinder liner in the cylinder bore can be achieved. Additional fixation means are not necessary. A simple configuration is provided thereby. To ensure correct assembly of the cylinder liner in the cylinder in a simple way, it is provided that the cylinder is provided with a step at the cylinder bore against which step the cylinder liner will rest.

It may also be provided that at least one segment of a side wall of the transfer passage is delimited by an insert. In this connection, the insert is arranged in particular spaced from the cylinder bore in the cylinder wall and therefore does not delimit the piston bearing surface of the cylinder. The insert delimits in this connection in particular the segment of the transfer passage that adjoins the opening to the crankcase. It can be particularly advantageous that the segment of the transfer passages is delimited completely by the insert, i.e., the transfer passages is surrounded in the area of the insert on all sides by the insert. In this way, the channel extension of the transfer passage can be selected substantially as desired.

A simple manufacture of the cylinder is achieved when the cylinder has at least one lid that delimits at least two transfer passages arranged adjacent to each other toward the outer side of the cylinder. In this connection, the lid can be provided in addition to an insert or a cylinder liner. Advantageously, the transfer passages are joined at the level of the lid.

In order to achieve low exhaust gas values of the internal combustion engine and a good combustion chamber scavenging action in operation, it is provided that the transfer passages extend at least partially at a slant to the longitudinal cylinder axis of the cylinder. Because of the spiral shape of the transfer passages the exhaust gas values can be clearly improved. The spiral shape can be produced by the suggested separate component in a simple way. In this connection, the transfer passages have in particular a common channel, and the common channel is arranged advantageously at the end of the transfer passages facing the crankcase. A minimal width of the internal combustion engine can be achieved when the opening of at least one transfer passage into the crankcase is arranged below the outlet. In particular, all transfer passages open with a common opening below the outlet.

### BRIEF DESCRIPTION OF THE DRAWINGS

The invention will be explained in the following in more detail with the aid of embodiments shown in the drawing.

FIG. 1 shows a section of a two-stroke engine in a schematic illustration.

FIG. 2 shows the exterior of the cylinder of FIG. 1 in a perspective representation.

FIG. 3 is a longitudinal section of the cylinder according to FIG. 2.

FIG. 4 is a section according to FIG. 3 in an enlarged representation showing a cylinder liner pressed into the cylinder.

FIG. 5 is a perspective representation of the cylinder liner according to FIG. 4.

FIG. 6 is a side view of the cylinder liner according to FIG. 5 in radial direction.

FIG. 7 shows the shape and course of the transfer passages.

FIG. 8 is a variant of the embodiment of FIG. 3.

FIG. 9 is a section view according to FIG. 8 with pressed-in cylinder liner in the cylinder.

FIG. 10 is a perspective representation of the cylinder liner according to FIG. 9.

FIG. 11 is a side view of the cylinder liner according to FIG. 10 in radial direction.

FIG. 12 is a first perspective representation of another embodiment of a cylinder liner.

FIG. 13 is a second perspective representation of the cylinder liner according to

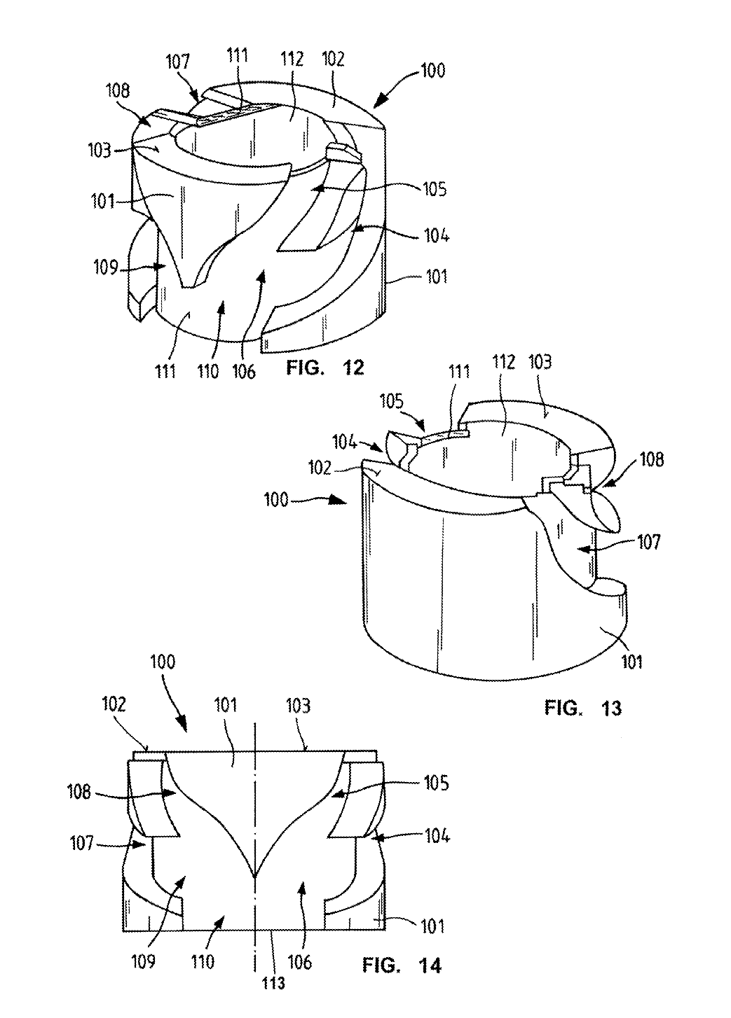

FIG. 12.

FIG. 14 is a side view of the wall of the cylinder liner.

FIG. 15 is an end view of the cylinder liner from below and rotated by 90° relative to the representation in FIG. 14.

FIG. 16 shows a side view of the wall of the cylinder liner, rotated by 90° relative to FIG. 14.

FIG. 17 is a plan view of the cylinder liner according to FIG. 16.

FIG. 18 shows an embodiment of a cylinder in exploded view.

FIG. 19 is a view from below of the cylinder of FIG. 18 in a direction of the arrow XIX of FIG. 18.

FIG. 20 shows the cylinder of FIG. 19 with inserts inserted into the cylinder.

FIG. 21 shows a section of the cylinder in the direction of the section line XXI-XXI of FIG. 20.

FIG. 22 shows a section of the cylinder along the section line XXII-XXII of FIG. 20.

FIG. 23 is a perspective exploded view of an embodiment of a cylinder.

FIG. 24 shows a longitudinal section of the cylinder of FIG. 23.

FIG. 25 is a section of the cylinder along the section line XXVI-XXVI, without insert arranged in the cylinder.

FIG. 26 is a section of the cylinder along the section line XXVI-XXVI with inserted insert.

FIG. 27 is a perspective representation of the insert.

FIG. 28 is a schematic section illustration of a two-stroke engine.

FIG. 29 shows the cylinder of the two-stroke engine of FIG. 28 in section.

FIG. 30 shows the cylinder of FIG. 29 with pressed-in cylinder liner.

FIG. 31 is a perspective representation of the cylinder liner of FIG. 30.

FIG. 32 is a first side view of the cylinder liner of FIG. 31.

FIG. 33 is a second side view of the cylinder liner of FIG. 31.

FIG. 34 is a third side view of the cylinder liner of FIG. 31.

FIG. 35 is a perspective representation of an embodiment of a cylinder liner.

FIG. 36 is a side view of the cylinder liner of FIG. 35.

FIG. 37 is a schematic developed illustration of transfer passages.

### DESCRIPTION OF PREFERRED EMBODIMENTS

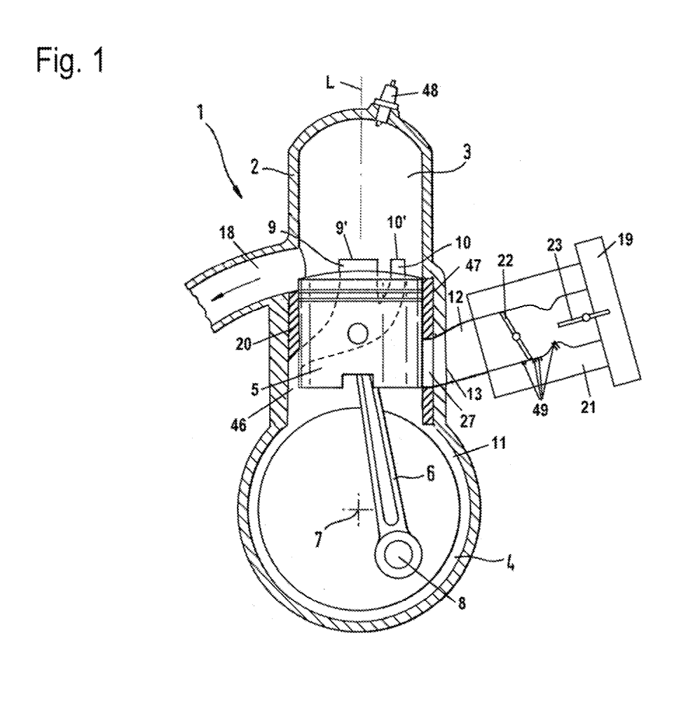

In FIG. 1 a two-stroke engine 1 is schematically shown that encompasses a cylinder 2 and a crankcase 4. In the cylinder 2 a combustion chamber 3 is formed that is delimited by a piston 5 that is supported in the cylinder 2 so as to reciprocate in the direction of a longitudinal cylinder axis L. A part of the bearing surface of the piston 5 is formed by cylinder liner 20 that is inserted into an enlarged part of the cylinder bore 47. The piston 5 drives by a connecting rod 6 a crankshaft 8 supported in the crankcase 4 so as to rotate about axis of rotation 7. In the position of the piston 5 shown in FIG. 1, the combustion chamber 3 is connected by means of four transfer passages 9 and 10—of which in this representation only two are visible—to a crankcase interior 11. The configuration of the transfer passages 9, 10 will be discussed in detail later on. At the upper ends of the transfer passages 9, 10 transfer ports 9′, 10′ are formed which are closed by the piston 5 upon upward movement of the piston 5.

At the cylinder 2 a mixture channel 12 opens through a mixture inlet 13. The mixture inlet 13 is connected by means of a cutout 27 in the cylinder liner 20, which is embodied as a through opening, with the crankcase interior 11. The connection of the mixture channel 12 to the crankcase 4 is piston-controlled by piston 5. The mixture channel 12 is connected by a carburetor 21 to an air filter 19. In the carburetor 21 several fuel openings 49 open into the mixture channel 12 and fuel is mixed in the carburetor 21 with combustion air sucked in through air filter 19 to a fuel/air mixture. For controlling the supplied combustion air quantity, in the carburetor 21 a throttle valve 22 and upstream of the throttle valve 22 a choke flap 23 are supported in a pivotable way. At the side of the cylinder 2 that is opposite the mixture inlet 13 an outlet 18 is arranged that extends away from the combustion chamber 3.

In operation of the two-stroke engine 1, when the piston 5 is in the area of top dead center, a fuel/air mixture is sucked through the mixture inlet 13 and the cutout 27 into the crankcase interior 11. With the downward stroke of the piston 5 the fuel/air mixture is compressed in the crankcase interior 11. As soon as the transfer ports 9′, 10′ are opened by the piston 5, fresh mixture from the crankcase interior 11 flows into the combustion chamber 3.

With the upward stroke of the piston 5 the fuel/air mixture is compressed in the combustion chamber 3 and is ignited in the area of top dead center of the piston 5 by a spark plug 48. The piston 5 is accelerated by the ignition in the direction of the crankcase 4. As soon as the outlet 18 opens, exhaust gases can stream out from the combustion chamber 3 and residual gases are scavenged by fresh mixture streaming in as soon as the transfer ports 9′, 10′ open.

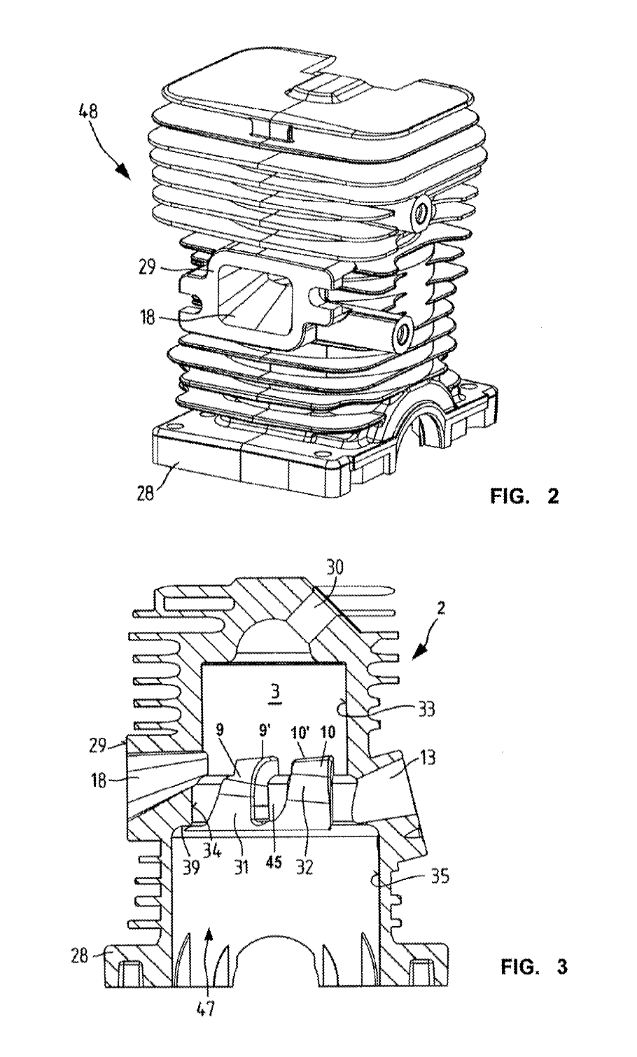

FIG. 2 shows the exterior of the cylinder 2 in perspective view. The cylinder 2 is provided on the exterior with cooling ribs and has at the lower end a flange 28 as a connection to the crankcase 4. On one side of the cylinder 2 there is the outlet 18 that is surrounded by a flange 29.

In FIG. 3 a longitudinal section of the cylinder 2 according to FIG. 2 is shown, wherein in the upper area the combustion chamber 3 is formed of first segment 33 of the cylinder bore 47 and a bore 30 for receiving the spark plug 48, not shown in FIG. 3, is provided. The mixture inlet 13 and the outlet 18 are arranged on opposite sides of the cylinder 2. Between the mixture inlet 13 and the outlet 18 there are depressions 31 and 32 in the inner wall of the cylinder 2 that extend essentially in vertical direction. In this axial area there is a second segment 34 of the cylinder bore 47 that is widened somewhat with respect to the diameter of the segment 33 and the mixture inlet 13 opens into this second segment 34. The depressions 31 and 32 are so designed that when producing the cylinder 2 by pressure die casting no undercuts are formed and the depressions 31 and 32 can be molded with a core that is pulled in the direction of the longitudinal cylinder axis L. The depressions 31 and 32 extend in axial direction of the longitudinal cylinder axis L across the entire second segment 34 and into the first segment 33. In this connection, the transfer ports 9′ and 10′ are embodied in the first segment 33. The second segment 34 projects up to the lower edge of the transfer ports 9′ and 10′.

A third segment 35 of the cylinder bore 47 with even bigger diameter adjoins the second segment 34 at its lower end so that a step 39 is formed in the cylinder 2 wherein the segment 35 extends to the end of the cylinder 2 at the flange 28.

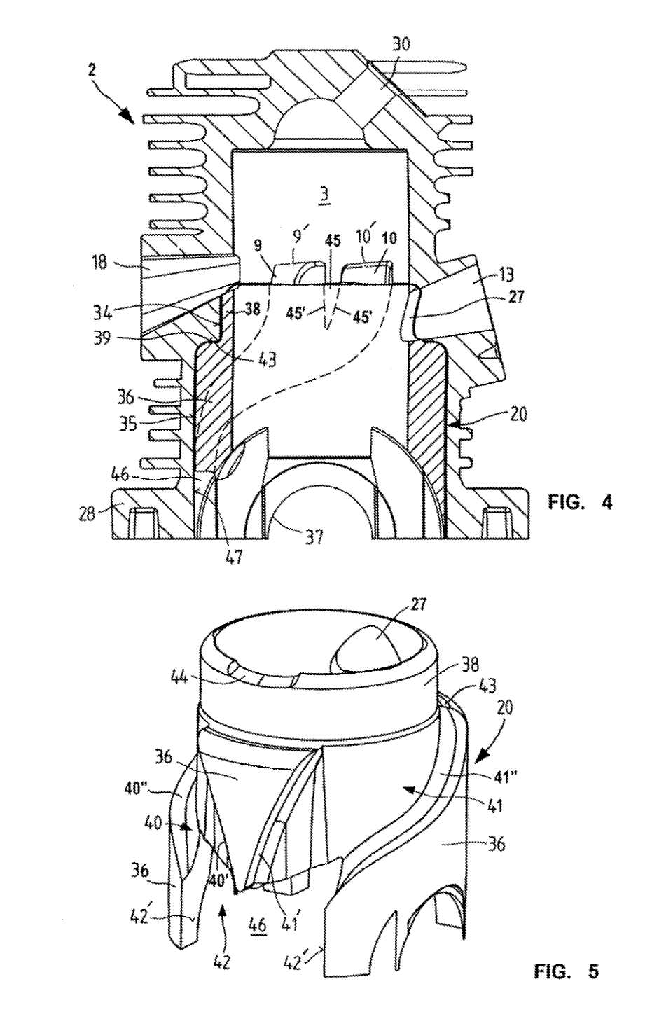

FIG. 4 shows a section of the cylinder 2 according to FIG. 3 in a somewhat enlarged representation and with a cylinder liner 20 pressed into the cylinder bore 47. The cylinder liner 20 has a sleeve body 36 having at its bottom end receiving surfaces 37 for a crankshaft bearing. The crankshaft bearing is thus received between the receiving surface 37 of the cylinder liner 20 and the crankcase 4. At the upper end of the cylinder liner 20 a sleeve segment 38 that is adapted with its outer diameter to the second segment 34 of the cylinder bore adjoins the sleeve body 36 and extends up to the upper end of the second segment 34. In this sleeve segment 38 the cutout 27 is provided which is facing the mixture inlet 13 and is embodied as a through opening. This sleeve segment 38 covers the depressions 31, 32 partially so that appropriate channels are formed that are a part of transfer passages 9, 10 to be explained in the following in greater detail. The upper ends of the depressions 31, 32 projects past the upper edge of the cylinder liner 20 and form in this manner transfer ports 9′ and 10′. The transfer passages 9 and 10 are delimited thus about their entire axial length relative to the cylinder interior by the cylinder liner 20. The transfer passages 9 and 10 open by openings 46 shown in FIG. 4 and arranged below the outlet 18, into the crankcase interior 11. In FIG. 4 the course of the transfer passages 9 and 10 in the cylinder liner 20 is indicated in dashed lines. As shown in FIG. 4, cylinder segment 45 that is monolithically (integrally) formed with the cylinder 2 projects into the upper area between the transfer passages 9 and 10 and separates the transfer passages 9 and 10 from each other. In this connection, the cylinder segment 45 extends advantageously in the second segment 34 of the cylinder 2. However, the cylinder segment 45 can also project into the area of the third segment 35.

In FIG. 5 a perspective representation of the cylinder liner 20 is shown which encompasses the sleeve body 36, the sleeve segment 38, and the receiving surfaces 37. In the wall of the sleeve body 36 channels 40, 41 are embodied that extend in circumferential direction and axial direction and are combined in the axially lower area to a common channel 42, wherein the channels 40, 41, 42 have side walls 40′, 41′, 42′, 40″ and 41″. It is clearly shown that the side walls 40′, 41′, 42′, 40″ and 41″ of the channels 40, 41, 42 are partially formed by the cylinder liner 20 and the channels 40, 41, 42 are delimited toward the inside of the cylinder 2 by the cylinder liner 20. In this connection, at least the side walls 40″ and 41″ that delimit the channels 40 and 41 in the direction of the crankcase 4 are monolithically (integrally) formed with the cylinder liner 20. The side walls 40′ and 41′ that delimit the channels 40 and 41 at the side below the outlet 18 and facing the combustion chamber 3 could also be monolithically formed on the cylinder 2. In case of monolithically formed side walls 40′ and 41′ on in the cylinder 2, the cylinder 2 when produced by pressure die casting could be removed from the mold with one pull core that is removable in the direction of the crankcase 4 because these side walls 40′ and 41′ have no undercuts in the direction of the crankcase 4. The side walls 40″ and 41″ which form undercuts in the direction of the crankcase 4 are completely monolithically formed on the cylinder liner 20 so as to be able to produce the cylinder 2 by pressure die casting. The segment 45 which separates the transfer passages 9 and 10 in the second segment 34 of the cylinder 2 is advantageously formed monolithically on the cylinder 2 when the side walls 45′ of the cylinder segment 45 shown in FIG. 4 are slanted in the direction of the crankcase 4 so that no undercuts result; in this way this cylinder segment 45 is producible also with one pull core that can be pulled in the direction of the crankcase 4 by pressure die casting.

In the upward direction, the depressions 31, 32 shown in FIG. 3 adjoin the channels 40, 41; these depressions 31, 32 represent the channels extending to the transfer ports 9′ and 10′ between the outer circumference of the sleeve segment 38 and the cylinder 2 and, in this way, form together with the channels 40, 41, 42 the transfer passages 9 and 10 whose shape and course are shown in FIG. 7. In this connection, in the channels 40 and 41 the outlet-near transfer passage 9 and the neighboring inlet-near transfer passage 19 extend together, respectively. The transfer passages 9 and 10 are separated from each other exclusively by the cylinder segment 45 monolithically formed on the cylinder 2. However, it can be also provided to realize a separation between the transfer passages 9 and 10 within the cylinder liner 20.

FIG. 5 moreover shows a depression 44 that is arranged at the upper edge of the sleeve segment 38 and is positioned below the outlet 18 and delimits the outlet 18. Furthermore, in the sleeve segment 38 the cutout 27 is provided which is facing the mixture inlet 13 in the mounted position of the cylinder liner 20 within the cylinder 2 and through which the fuel/air mixture is supplied to the crankcase interior 11.

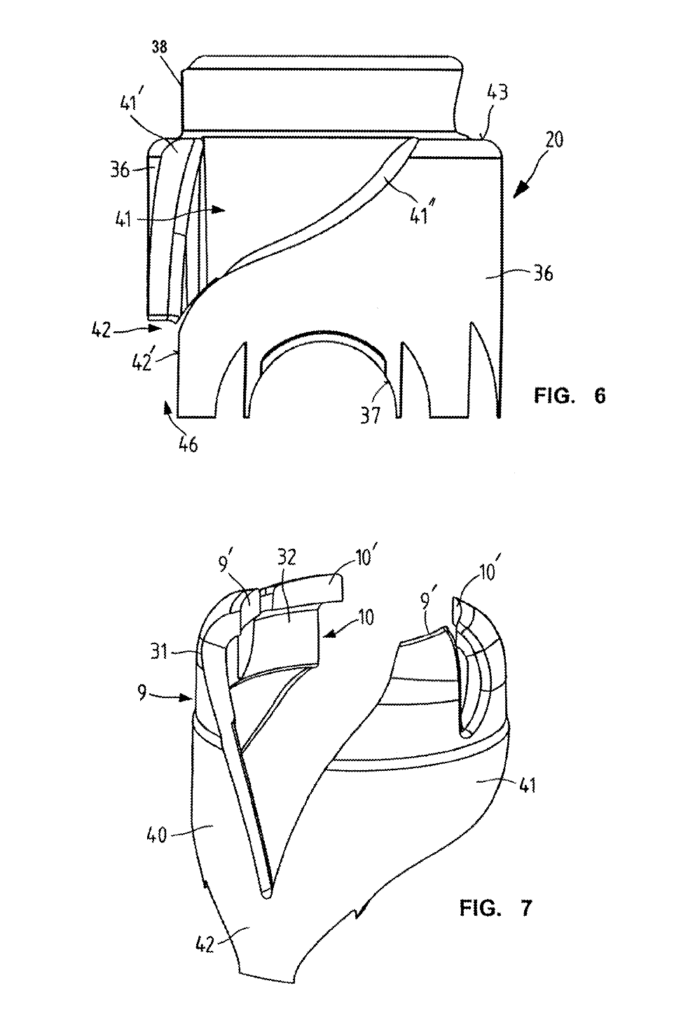

FIG. 6 shows a view of the cylinder liner 20 according to FIG. 5 in the mounted position according to the section view of FIG. 4. This Figure shows the sleeve body 36, the receiving surface 37, the sleeve segment 38, and the channels 41, 42. On the outer contour a shoulder 43 is formed between the sleeve body 36 and the sleeve segment 38 that serves as a contact surface for the step 39 of the cylinder bore shown in FIG. 4.

FIG. 7 shows the shape and the course of the transfer passages 9 and 10 that begin at the transfer ports 9′ and 10′ and are formed by the depressions 31, 32 as well as the channels 40, 41 and 42, wherein the initial four channels are combined to a common channel that opens into the crankcase interior. In this connection, first a transfer passage 9 close to the outlet and a neighboring transfer passage 10 close to the inlet are combined, respectively, to two channels 41, 42. Then, these two channels 40, 41 are combined below the outlet 18 to a common channel 42. It is also possible that a different number of transfer passages, for example, three on each cylinder side, i.e., a total of six transfer passages, are provided.

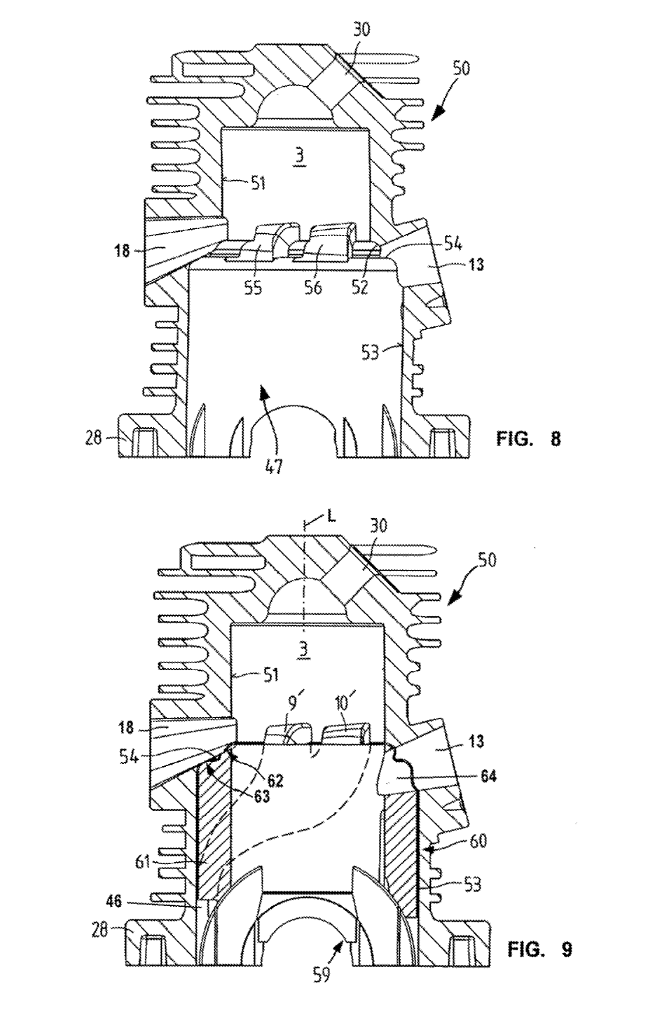

FIG. 8 shows a longitudinal section of a cylinder 50 that is similar to the cylinder 2 of FIG. 3. The difference is that the cylinder bore 47 has a transitional segment 52 between the first segment 51 and the third segment 53 that is axially short and has a greater diameter, this segment 52 is formed above a step 54. Therefore, depressions 55 and 56 for the transfer passages 9 and 10 embodied in the cylinder bore are only short and end at the step 54. The combustion chamber 3, the bore 30 and the flange 28 are identical to those of FIG. 3. FIG. 8 shows that the cylinder bore is embodied smooth or flat in the third segment 53 with the exception of the recesses for the crankshaft 8. The cylinder wall in the third segment 53 delimits the transfer passages 9 and 10 outwardly but does not constitute a limitation in the circumferential direction relative to the longitudinal cylinder axis L. In the circumferential direction, the transfer passages in the third segment 53 are delimited exclusively by the cylinder liner 60 (FIG. 9).

FIG. 9 shows a section of the cylinder 50 according to FIG. 8 with a cylinder liner 60 pressed into the cylinder bore. The cylinder liner 60 has a sleeve body 61 having at its bottom end receiving surfaces 59 for a crankshaft bearing and at its upper end, at the end face, a monolithically formed bead 62 that extends circumferentially. The bead 62 has compared to the sleeve body 61 a reduced external diameter so that a shoulder 63 is formed which comes to rest against the step 54. The external diameter of the bead 62 covers the depressions 55 and 56 at their lower area so that short channels are formed. The upper ends of the depressions 55, 56 project past the bead 62 and form transfer ports 9′, 10′ as in FIG. 4. In the sleeve body 61 a cutout 64 is provided that is facing the mixture inlet 13 and is embodied as a through opening and through which a fuel/air mixture passes into the crankcase interior 11 when the cutout 64 is released by the piston 5. For all remaining features the reference numerals are the same as in FIG. 8.

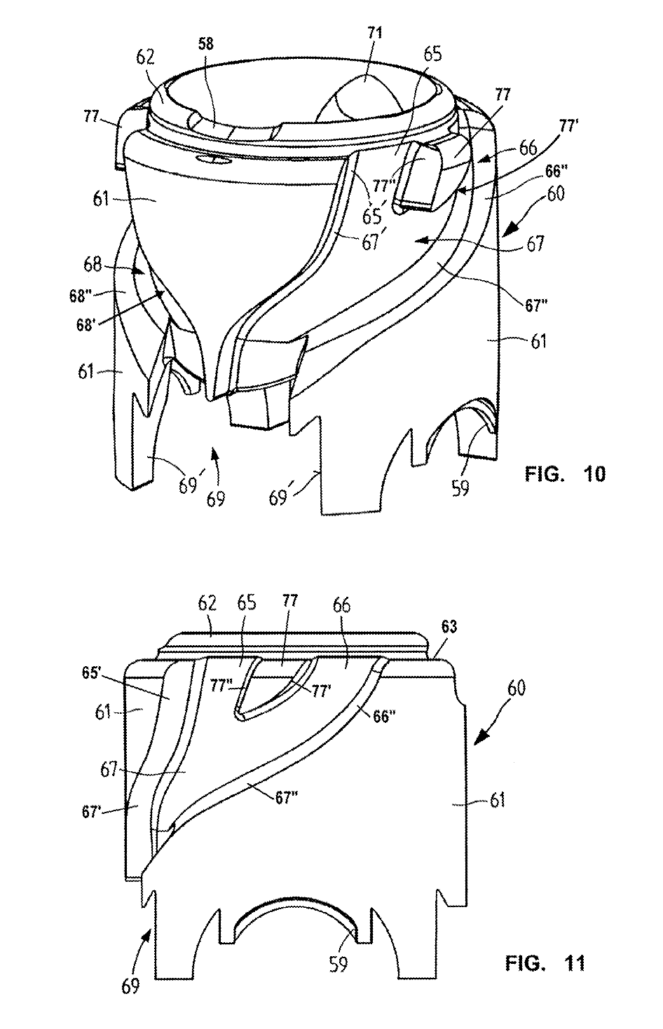

FIG. 10 is a perspective representation of the cylinder liner 60 with the sleeve body 61, the monolithically formed bead 62 at the end face, and the receiving surface 59 for a crankshaft bearing. In the wall of the sleeve body 61, there are channels 65, 66, 67, 68, 69 that extend in circumferential direction and in axial direction and are covered by the inside wall of the third segment 53 when the cylinder liner 60 is pressed into the cylinder 50. The channels 65, 66, 67, 68, 69 are laterally delimited by side walls 65′, 67′, 68′, 69′, 66″, 67″ and 68″. The channels 65 and 66 that adjoin the depressions 55 and 56 are combined to the channel 67 in which the transfer passages 9 and 10 extend together. The channels 65 and 66 are separated from each other by the dividing segments 77 that are monolithically formed with the cylinder liner 60 and extend, when the cylinder liner 60 is pressed into the cylinder 50, in radial direction up to the cylinder bore. The transfer passages 9 and 10 are in this way separated from each other partially also in the third segment 53 of the cylinder 50. In this connection, at the dividing segment 77 side walls 77′ and 77″ are formed which delimit the channels 65 and 66.

Two channels (hidden in the illustration) that are positioned on the opposite side of the sleeve body 61 are embodied mirror-symmetrically to the channels 65 and 66 and are combined to a channel 68. The channels 67 and 68 are combined, finally, to a common channel 69 which opens into the crankcase interior 11. In this embodiment, the side walls of the channels are formed by the cylinder liner 60. In this connection, at least the side walls 66″, 67″ and 68″ that are facing the crankcase and, when viewed from the crankcase, form undercuts that are formed completely within the cylinder liner 60. Also, the wall 77″ of the partition segment 77 must be embodied on the cylinder liner 60 because this wall forms an undercut, i.e., it is hidden when viewed from the crankcase 4 in the direction of the longitudinal cylinder axis L. The side walls 65′ and 67′ facing the combustion chamber 3 may also be monolithically formed on the cylinder 50. Because these side walls 65′ and 67′ do not form undercuts when viewed from the crankcase 4, a cylinder 50 having these side walls monolithically formed thereon could be removed from a mold in a pressure die casting process by using a core that is pulled in the direction of the longitudinal cylinder axis L. On the bead 62 a depression 58 is provided that is positioned in the mounted position below the outlet 18. Moreover, a cutout 71 embodied as a through opening is provided in the sleeve body 61 and is facing the mixture inlet 13 in the cylinder 50.

FIG. 11 shows a view of the cylinder liner 60 in radial direction and this position correspond to the mounted position in the cylinder 50, as shown in FIG. 9. The Figure shows the sleeve body 61, the bead 62, and the receiving surface 59. On the sleeve body 61 the shoulder 63 is formed at the upper end and, in the pressed-in state of the cylinder liner 60, it rests against the step 54, as shown in FIG. 9. The channels 65, 66 and 67 extend in a spiral shape about the circumference of the sleeve body 61, as does the channel 68 shown in FIG. 10. The common channel 69 extends in axial direction. As is shown in FIG. 10, the side walls 65′, 67′ and 77′ are facing the crankcase 4. Viewed from the crankcase 4, these side walls are partly visible. The side walls 66″, 67″ and 77″ are facing the combustion chamber 3 and are partly visible when viewed from the combustion chamber 3. When viewed from the crankcase 4 these side walls are hidden and form undercuts. Therefore, the side walls 66″, 67″ and 77″ must be monolithically formed on the cylinder liner 60 so that the cylinder 50 can be removed from the mold when it is produced by pressure die casting with a core that is pulled in the direction of the crankcase 4. The side walls 65′ and 67′ could also be monolithically formed on the cylinder 50. Also, the side wall 77′ could be at least partially monolithically formed on the cylinder 50 when the dividing segment 77 is of a divided embodiment and formed partially on the cylinder 50. Since the side walls 66″, 67″, 77″ that extend in circumferential direction of the transfer passages 9, 10 and form undercuts are formed monolithically on the cylinder liner 60, the cylinder 50 can be produced in a simple way by pressure die casting without lost cores.

As can be taken from the preceding description of the embodiments, an essential feature of these designs is to be seen in the fact that the channels extend at a slant to the longitudinal cylinder axis of the cylinder, i.e., the openings of the transfer passages into the combustion chamber 3 that are formed by transfer ports 9′, 10′ are displaced in the circumferential direction relative to the openings 46 (FIG. 4) of the channels into the crankcase 4 or the crankcase interior 11. Because the channels are arranged on the outside of the cylinder liner and at least one side wall of the channels is formed by the cylinder liner, a simple production of the cylinder is possible. A pressure die casting tool for such a cylinder can be embodied in a simple way because only one division plane is required for mold removal. Also, the production of the cylinder liner is possible by a simple tool and the necessary surface condition is generated by finish-machining of the wall of the cylinder liner, for example, by fine-turning. In this manner, the necessary seal-tightness is achieved after pressing the cylinder liner into the case of the cylinder.

FIG. 12 shows a perspective view of another embodiment of a cylinder liner 100. It encompasses a sleeve body 101 that has at its top side two flange surfaces 102 and 103 between which channels 104, 105 introduced into the wall of the sleeve body 101 and channels 107, 108 begin. These channels 104, 105 or 107, 108 extend in circumferential direction and in axial direction so that their course is essentially spirally shaped. The channels 104, 105 are combined after a certain distance to a common channel 106 and the channels 107, 108 are combined likewise to a channel 109. The channels 106 and 109 are combined, finally, to a common channel 110. The channels 104 to 110 are delimited each by side walls, as has already been illustrated and explained in connection with FIG. 5 and FIG. 10. At the cylinder liner 100, a wall 111 that separates the channels 104 to 110 from a bore 112 extends up to a lower edge of the sleeve body 101 so that only below this edge a connection to the crankcase interior 11, shown in FIG. 1, is provided. The channels 104 to 110 are covered by an inner wall of the cylinder when the cylinder liner 100 is pressed into the cylinder. Then the bore 112 forms a segment of the piston bearing surface.

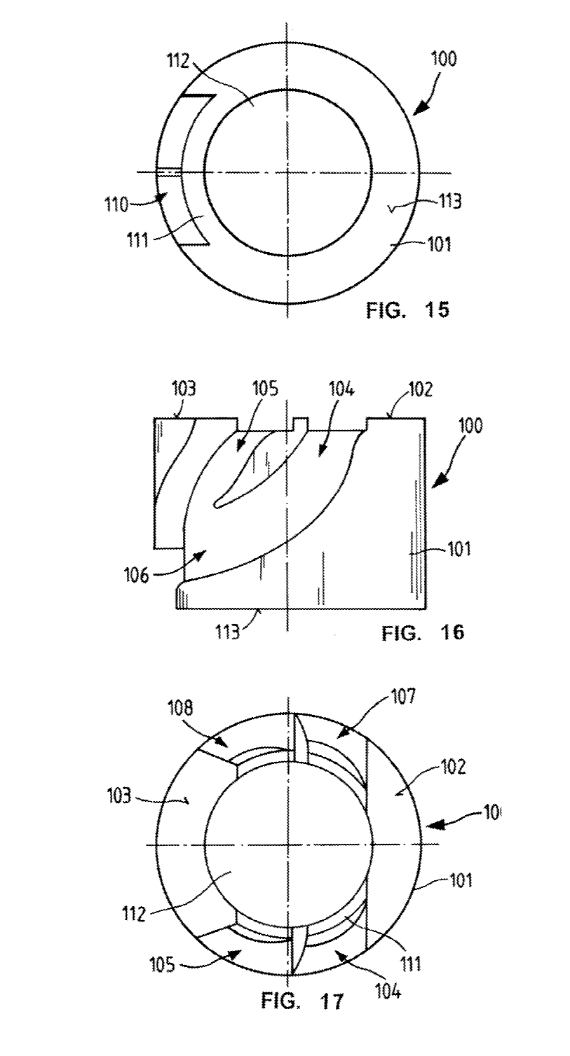

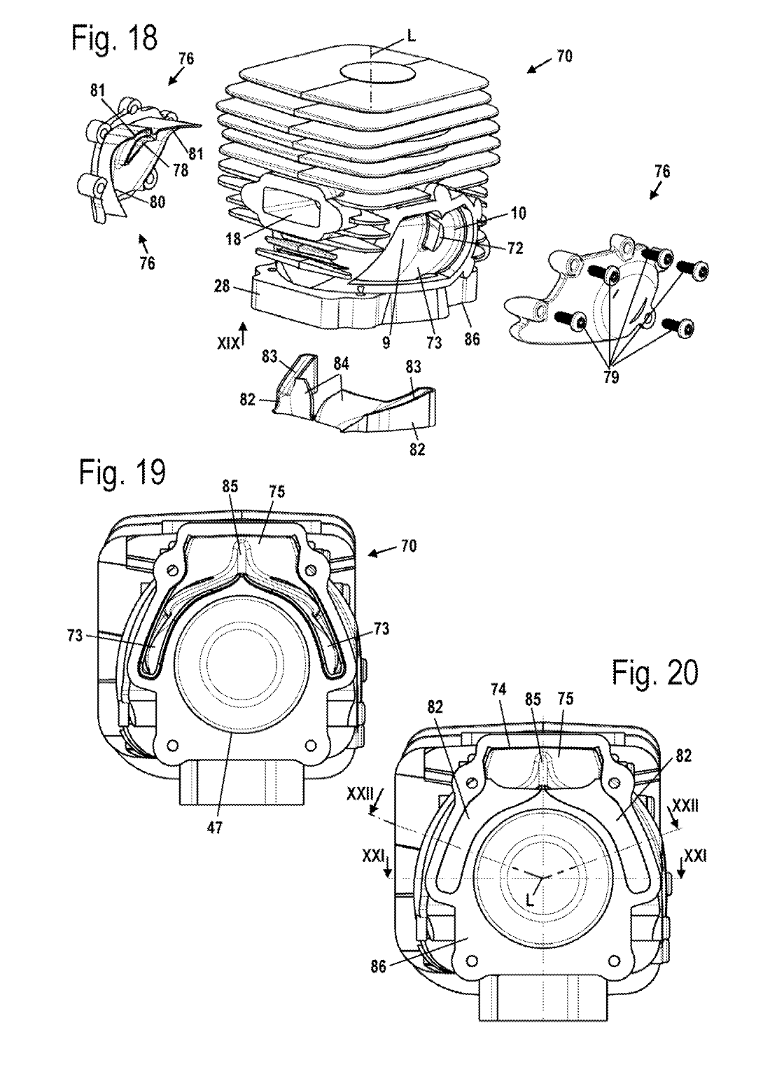

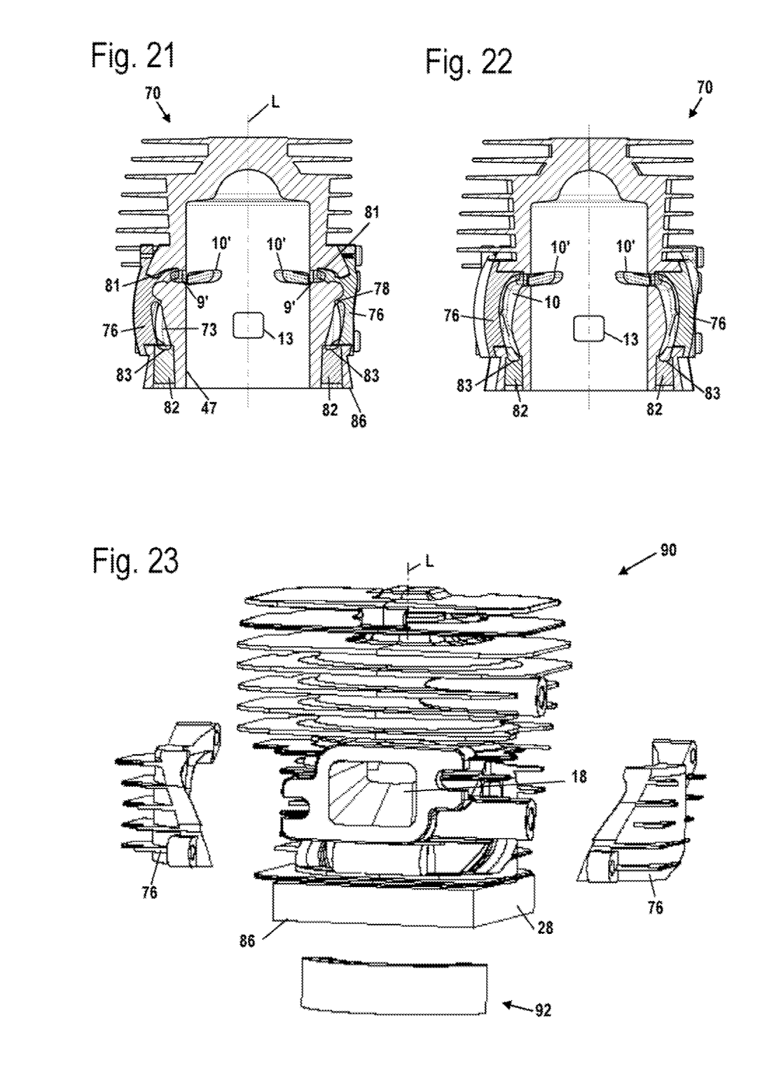

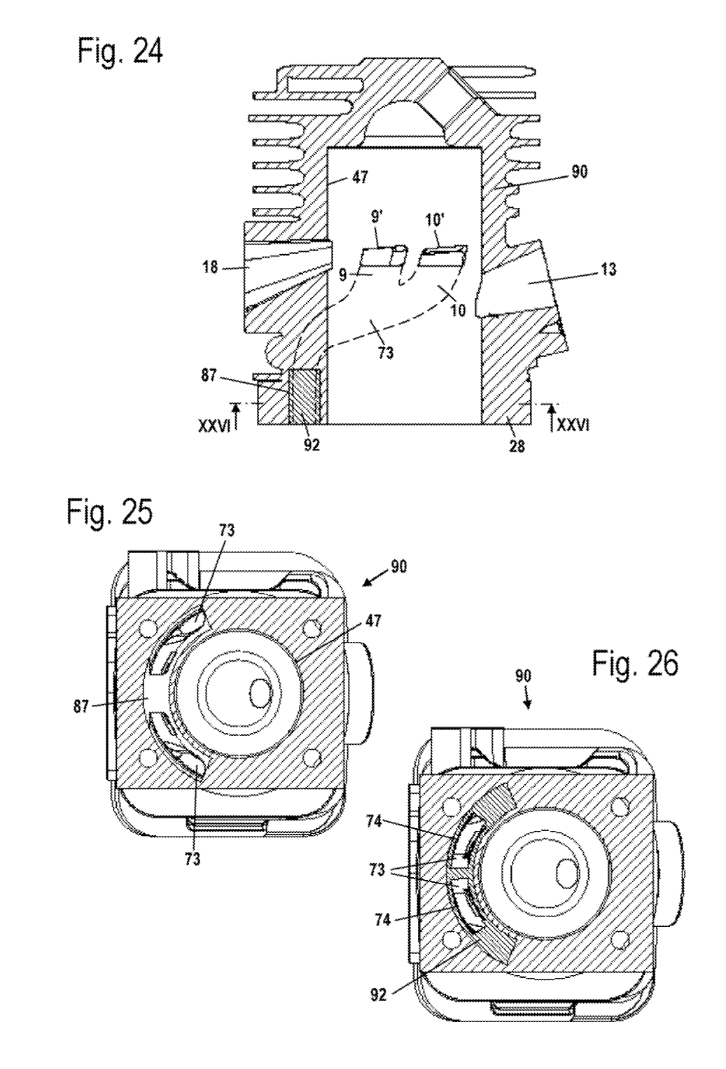

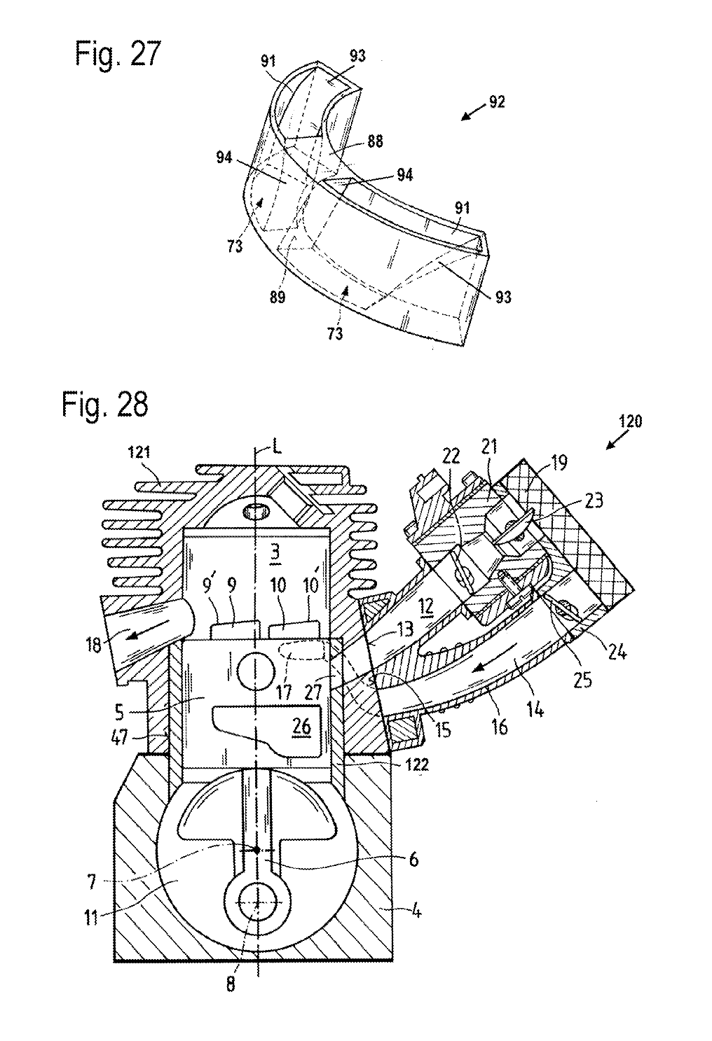

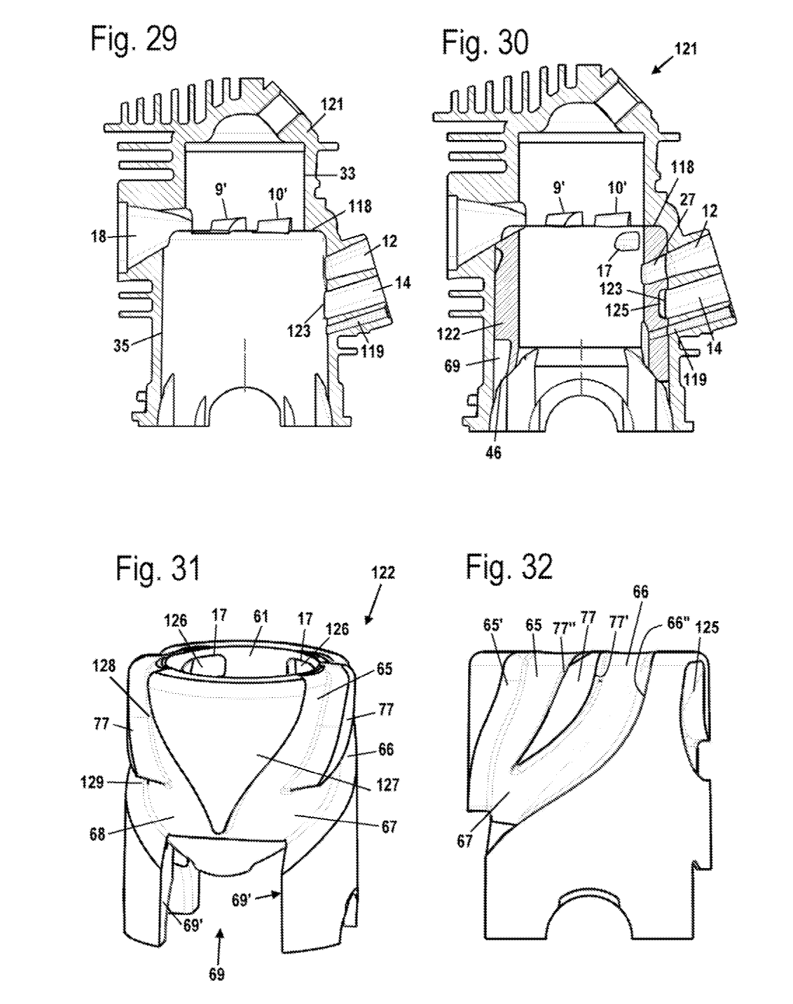

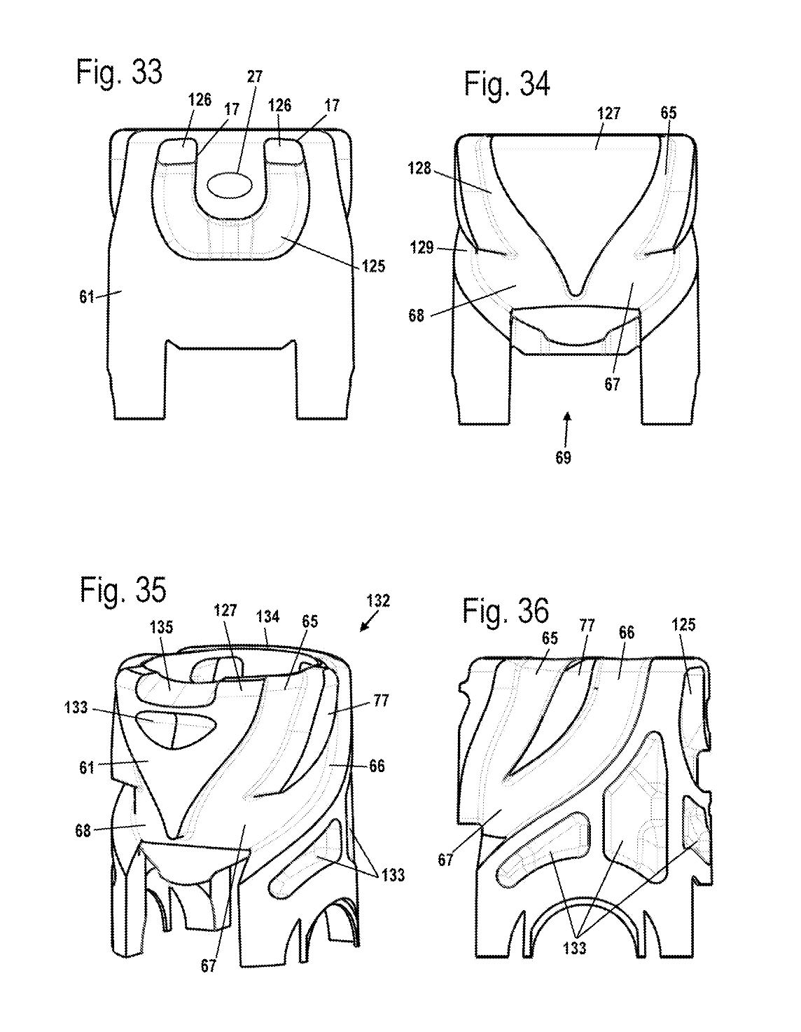

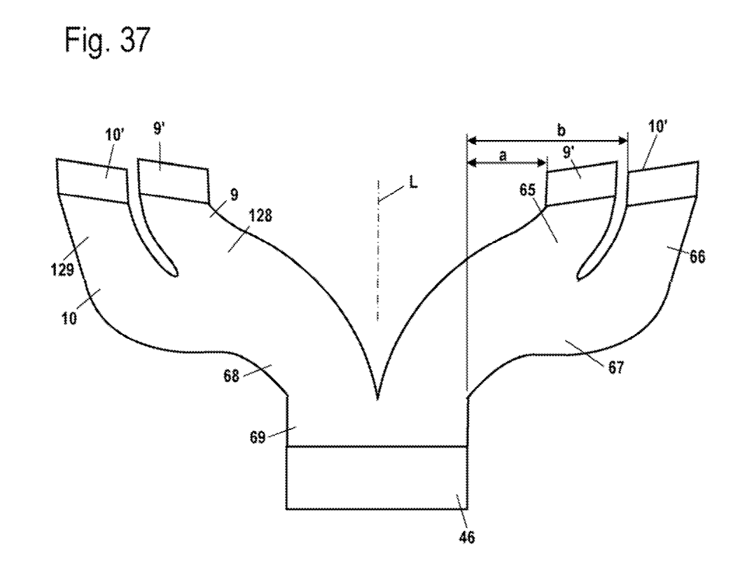

FIG. 13 shows the cylinder liner 100 in another perspective view wherein only the channels 104, 105 as well as 107, 108 in the sleeve body 101 are shown in this illustration. The remaining reference numerals indicate same features as in FIG. 12; the same holds true for FIG. 14 that shows a view of the wall surface of the sleeve body 101, namely of the area that shows the channel extensions as a whole. As shown in FIG. 14, the channels 104 and 105 are combined at a central axial height of the cylinder liner 100 to form the channel 106. The same holds true for the mirror-symmetrically embodied channels 107, 108 and 109. The channels 106 and 109 are combined to the channel 110 at a spacing to the bottom side 113.

FIG. 15 shows a view of the bottom side 113 of the cylinder liner 100. In the sleeve body the bore 112 is arranged and radially beyond the wall 111 the channel 110 with its side walls is formed. FIG. 16 shows the sleeve body 101 in a side view of the outer circumference where the channels 104, 105 and 106 are embodied, wherein the upper flange surfaces 102, 103 form a common plane and at the lower edge of the sleeve body 101 the bottom side 113 is located. In this connection, the flange surfaces 102, 103 extend at the level of the transfer ports 9′ and 10′. The lower part of the transfer ports 9′ and 10′ is delimited by the cylinder liner 100 that projects up to about half the height of the transfer ports 9′ and 10′. The upper edge of the transfer ports 9′ and 10′ is embodied in the cylinder, not shown. The transfer ports 9′ and 10′ can be also embodied in the cylinder liner 100 with the exception of the upper edge. This provides for a simple design of the cylinder.

In FIG. 17 a plan view is shown of the cylinder liner 100 with flange surfaces 102, 103 arranged on the sleeve body 101 and the channels 104, 105 as well as 107, 108 introduced into the sleeve body 101 that are separated by the wall 111 of the bore 112.

In the FIGS. 18 to 22 an embodiment of a cylinder 70 is shown where the transfer passages are sealed relative to the exterior of the cylinder by lids 76. In this connection, a lid 76 is provided, respectively, for two adjacently arranged transfer passages 9 and 10. The lids 76 delimit the transfer passages 9 and 10 in radial direction relative to the longitudinal cylinder axis L from the level of the transfer ports 9′ and 10′ to a point above the flange 28 of the cylinder 70 in outward direction. In this connection, in FIGS. 18 to 22 the same reference numerals indicate same elements as in the preceding figures.

The lids 76 are secured by five fastening bolts 79 to the cylinder 70, respectively. On each lid 76 a partition 78 is secured that interacts with a cylinder segment 72. The transfer passages 9 and 10 are separated by the partition 78 and the cylinder segment 72 in the area that adjoins the transfer ports 9′ and 10′. In this connection, the partition 78 is essentially positioned so as to rest against the cylinder segment 72 in the radial outward direction of the cylinder segment 72. Adjacent to the transfer ports 9′ and 10′, the partition 78 projects to a point close to the transfer ports 9′ and 10′.

On the lids 76 a wall segment 80 is monolithically formed that delimits a side wall of the transfer passage 9 that extends in circumferential direction, namely the sidewall of the transfer passage 9 that is facing the outlet 18. Moreover, on the lids 76 there are monolithically formed cover segments 81 which delimit the transfer passages 9 and 10 in the direction of the cylinder top.

As shown in FIG. 18, the transfer passages 9 and 10 are combined to a common channel 73 on the side of the cylinder segment 72 that is facing the crankcase 4. The contours of the channels 73 embodied in the cylinder 70 are open toward the flange 28. This is shown in the view from below onto the cylinder 70 in FIG. 19. The transfer passages 9 and 10 when producing the cylinder 70 by pressure die casting can be removed from the mold when using pull cores that can be pulled downwardly toward the crankcase 4 and, in the area of the lid 76, can be pulled in radial outward direction. Lost cores are therefore not necessary for producing the cylinder 70. The channels 73 are delimited toward the crankcase by inserts 82 on which a side wall 83 is formed that delimit the channels 73 toward the crankcase 4; the channels 73 are further delimited by an inner wall 84 that delimits the channels 73 toward the cylinder interior and that has a curved contour so that favorable flow conditions result in the transfer passages 9 and 10. The channels 73 are embodied mirror-symmetrically to a symmetry plane containing the longitudinal cylinder axis L wherein for each channel 73 one insert 82 is provided.

FIG. 19 also shows that the channels 73 of both cylinder sides are separated from each other by a dividing segment 85 which is monolithically formed on the cylinder 70. Above the bottom side 86 of the flange 28 and at a short distance to this bottom side 86 the channels 73 of both cylinder sides are combined to a common channel 75. The channel 75 opens at the bottom side 86 with an opening 74 into the crankcase. The opening 74 is arranged below the outlet 18, so that all transfer passages 9 and 10 open below the outlet 18 into the crankcase 4. A different number of transfer passages on each cylinder side may also be suitable. It may also be provided that the transfer passages 9 and 10 on opposite cylinder sides are embodied differently or that a different number of transfer passages on the two cylinder sides are used.

FIG. 20 shows a view of the bottom side 86 of the cylinder 70 with inserts 82 inserted into the transfer passages. With the exception of the opening 74 the transfer passages 9 and 10 are sealed relative to the crankcase by the inserts 82.

In FIGS. 21 and 22 the cylinder 70 is shown in section. FIG. 21 in this connection shows a section through the transfer port 9′ close to the outlet and FIG. 22 shows a section of the transfer port 10′ close to the inlet. As shown in FIG. 21, the partition 78 projects up to the inner wall of the transfer passages 9 and 10 facing the cylinder bore 47. The cover segment 81 projects to a point close to the cylinder bore 47. In this connection, undercuts that would result when producing the cylinder 70 by pressure die casting with cores pulled outwardly relative to the longitudinal cylinder axis L are formed by the lids 76. In this connection, the cores for producing the contours must not be pulled directly radial outwardly but can also be pulled at a slant laterally. The production can thus be simplified. As shown in FIG. 21, the side walls 83 in the inserts 82 limit the transfer passages toward the bottom side 86 of the cylinder 70.

As shown in FIG. 22, the transfer passages 9 and 10 are delimited toward the exterior of the cylinder by the lids 76. By combination of lids 76 and inserts 82 a simple design of the cylinder 70 results.

FIG. 23 shows an embodiment of a cylinder 90 whose transfer passages are also delimited by lids 76 in the radial outward direction of the cylinder. In this connection, the design of the lids 76 can correspond approximately to the lid design shown in FIGS. 18 to 22. As shown in the exploded view of FIG. 23, the transfer passages 9 and 10 are delimited toward the crankcase 4 by a common insert 92 that is inserted into the cylinder 90 from the bottom side 86 facing the crankcase 4 in a direction parallel to the longitudinal cylinder axis L. FIG. 24 shows the arrangement of the insert 92 in a receptacle 87 of the cylinder. As shown also in FIG. 25, the receptacle 87 extends in a circular arc shape about the cylinder bore 47. As shown in FIG. 24, the receptacle 87 with the insert 92 extends about the entire height of the flange 28. Above the flange 28 the lids 75 shown in FIG. 23 adjoin so that the transfer passages 9 and 10 are delimited advantageously roughly about their entire length at every cross-section by an additional component and do not extend exclusively in the cylinder 90.

As shown in FIG. 26, the channels 73 extend within the insert 92 separate from each other. Both channels 73 are not combined in the cylinder 90 to a common channel, but open as separate channels into the crankcase.

This is also shown in the representation of FIG. 27. As shown in FIG. 27, the insert 92 is embodied as a ring segment having a flat top side 88 and an opposed flat bottom side 89; through passages 91 open at the top and bottom sides 88, 89 and form the channels 73. The top side 88 and the bottom side 89 are the end faces of the insert 92 that are positioned perpendicularly to the longitudinal cylinder axis L. As shown in FIG. 27, the through passages 91 are curved. The through passages 91 have side walls 94 that extend in radial direction and neighbor each other and are visible in a view from the crankcase. The opposite side walls 93 are visible in a view from the combustion chamber 3 and represent undercuts in a view from the crankcase 4. Therefore, the through passages 91, if embodied in the cylinder 90, could not be removed from the mold with cores that are pulled in the longitudinal direction L of the cylinder. The insert 92 is so embodied that it can be inserted from the side of the cylinder 90 facing the crankcase 4 into the cylinder 90 so that the cylinder 90 can be produced in a simple way by pressure die casting.

A different design of inserts for the limitation of the transfer passages can be provided also. In this case, advantageously at least one side wall of a transfer passage, which is hidden in a view from the crankcase toward the combustion chamber and forms in this direction an undercut, is embodied on the insert. The side walls that in a view from the crankcase are visible and extend parallel to the longitudinal cylinder axis L may be embodied on the cylinder 90 and must not be delimited by separate inserts.

FIG. 28 shows an embodiment of a two-stroke engine 120 that is embodied as a motor operating with scavenging air. The same reference numerals as in the preceding Figures indicate same components. The two-stroke engine 120 has a cylinder 121 in which a mixture channel 12 as well as a supply channel 14 for air that is substantially free of fuel open. The supply channel 14 opens with a supply channel inlet 17 at the cylinder bore 47. In this connection, there are provided advantageously two supply channel inlets 17 that each are arranged below the transfer port 10′ of an inlet-near transfer passage 10. The piston 5 has a piston recess 26 that connects the supply channel inlet 17 in the area of top dead center of the piston 5 with the transfer ports 9′ and 10′ so that into the transfer passages 9 and 10 air that is substantially free of fuel can be supplied by supply channel 14. This scavenging air flows upon upward stroke of the piston into the combustion chamber 3 as soon as the transfer ports 9′ and 10′ are opened by the piston 5. The scavenging air scavenges the exhaust gases from the combustion chamber 3 through the outlet 18 and separates the fresh mixture that is coming in from the crankcase interior 11 from the exhaust gases. Reduced exhaust gas values can be achieved in this way.

The supply channel 14 is embodied in a connecting socket 16 which is secured on a connecting flange 15 of the cylinder 121. The mixture channel 12 is embodied also on the connecting socket 16. The supply channel 14 is also connected with the air filter 19. The segment of the supply channel 14 that adjoins the air filter 19 is embodied in a channel component 24 in which a control flap 25 is arranged which controls the amount of supplied scavenging air. The position of the control flap 25 is coupled advantageously to the position of the throttle valve 23 in the carburetor 21 so that a good ratio of fuel/air mixture supplied through the mixture channel 12 and of scavenging air supplied through the supply channel 14 results.

As shown in FIG. 28, a cylinder liner 122 is inserted into the cylinder 121 which extends to the lower edge of the transfer ports 9′ and 10′ facing the crankcase 4.

FIG. 29 shows the cylinder 121 without cylinder liner 122. As shown in FIG. 29, the cylinder 121 has a first segment 33 that is directly adjoined by a second segment 34 with larger diameter. Into the second segment 34 the mixture channel 12 and the supply channel 14 open while in the first segment 33 the transfer ports 9′ and 10′ are arranged. Between the first segment 33 and the second segment 34 a step 118 is formed. As shown in FIG. 29, the supply channel 14 opens with an opening 123 into the cylinder interior.

As shown in FIG. 30, the cylinder liner 122 is pressed into the third segment 35 of the cylinder 121. In the pressed-in position, the cylinder liner 122 is positioned on the step 118 and projects up to the lower edge of the transfer ports 9′ and 10′. The cylinder liner 122 has a cutout 27 that is embodied as a through opening and connects the mixture channel 12 with the cylinder interior. In the area of the opening 123 the cylinder liner 122 has a supply channel section 125 that extends in an arc shape upwardly and forms a segment of the supply channel 14 extending in the cylinder 121. In this connection, the supply channel sections 125 connect the opening 123 with the supply channel inlets 17 formed in the cylinder liner 122. The cylinder 121 is embodied with smooth walls in the area that is facing the supply channel sections 125. The cylinder liner 122 seals the opening 123 in the direction toward the cylinder interior.

As shown in FIGS. 29 and 30, an pulse channel 119 is formed in the cylinder flange in addition to the mixture channel 12 and the supply channel 14 and this pulse channel opens also into the crankcase.

The FIGS. 31 to 34 show the design of the cylinder liner 122 in detail. The cylinder liner 122 has a sleeve body 61 in which channels 65, 66, 67, 68, 128, 129 and 69 are introduced. The channels 65 and 66 are separated by a dividing segment 77 from each other and are combined below the dividing segment 77 to form a common channel 67. Correspondingly and mirror-symmetrically the channels 128 and 129 on the other side of the cylinder liner 122 are combined to form a common channel 68. The channels 67 and 68 are combined below the outlet to a channel 69. Below the outlet a sleeve segment 127 is arranged that separates the channels 65 and 128 from each other. The sleeve segment 127 may also be monolithically formed on the cylinder 120. The sleeve segment 127 also separates the channels 67 and 68 from each other.

As shown in FIG. 33, the cylinder liner 122 has through openings 126 where the supply channel openings 17 are embodied. The through openings 126 are connected by the means of the supply channel section 125 that is embodied in a U-shape and surrounds the cutout 27 for the mixture channel 12 so that the mixture channel 12 is separated from the supply channel 14.

The FIGS. 35 and 36 show an embodiment of a cylinder liner 132 whose design corresponds essentially to the design of the cylinder liner 122. The same reference numerals indicate same components. The cylinder liner 132 has in the sleeve segment 127 a depression 133 which is embodied as a hollow in the exterior of the sleeve body 61. The depression 133 serves for weight reduction of the cylinder liner 132 and is sealed by the cylinder 121 completely. Further depressions 133 are provided below the channel 66 and below the supply channel section 125. As shown in FIG. 35, the cylinder liner 132 has a top side 134 that is provided with a groove 135 for the outlet 18. The top side 134 projects up to the shoulder 118 when the cylinder liner 132 is inserted into the cylinder 121.

In all shown transfer passages the transfer ports 9′ and 10′ are arranged relative to the opening 46 of the transfer passages at the crankcase 4 so as to be displaced in the circumferential direction of the cylinder relative to each another. FIG. 37 shows a schematic developed view of the transfer passages. As shown in this Figure, the transfer port 9′ close to the outlet has relative to the opening 46 a distance a measured in the circumferential direction of the cylinder. The opening 46 is displaced relative to the transfer port 9′ in the circumferential direction of the cylinder. The transfer port 10′ has relative to the opening 46 a distance b measured in circumferential direction of the cylinder that is clearly greater than the distance a. The opening 46 does not overlap the transfer ports 9′ and 10′ in the direction of the longitudinal cylinder axis L. Because of the spirally shaped course of the transfer passages 9 and 10, the transfer passages cannot be molded with cores that are pulled in the longitudinal direction of the cylinder. In order to enable despite of this a production of the cylinder by pressure die casting, at least one insert is provided that delimits a side wall of a transfer passage. In this connection, the side wall is embodied such that its entire depth measured in radial direction relative to the longitudinal cylinder axis L is provided on the insert so that the cylinder can be embodied in this area to be smooth or flat. In this way, a simple manufacture is enabled.

The proposed design of the cylinder with at least one insert may be also advantageous in connection with transfer passages that are differently shaped or in connection with a different number of transfer passages. The transfer ports and the openings at the crankcase must not have a spacing relative to each other but may be displaced minimally relative to each other.

The specification incorporates by reference the entire disclosure of German priority document 10 2009 059 144.3 having a filing date of Dec. 19, 2009.

While specific embodiments of the invention have been shown and described in detail to illustrate the inventive principles, it will be understood that the invention may be embodied otherwise without departing from such principles.

What is claimed is:

1. A two-stroke engine comprising:
a cylinder with a combustion chamber disposed therein;
a piston reciprocatingly supported in the cylinder and delimiting the combustion chamber;
a crankshaft rotatably supported in a crankcase and driven by the piston;
at least one transfer passage connecting the crankcase in at least one position of the piston with the combustion chamber, wherein the transfer passage has a piston-controlled transfer port that opens into the combustion chamber and an opening that opens into the crankcase;
a mixture inlet that opens into the crankcase;
an outlet provided at the combustion chamber;
wherein the transfer port and the opening are displaced relative to each other in a circumferential direction of the cylinder;
wherein at least one wall section of the transfer passage forms an undercut when viewed from the crankcase in a direction of a longitudinal cylinder axis of the cylinder;
wherein the at least one wall section is delimited by a separate component that is inserted into the cylinder from a side facing the crankcase.

2. The two-stroke engine according to claim 1, wherein the separate component is a cylinder liner.

3. The two-stroke engine according to claim 2, wherein the cylinder liner extends from a side of the cylinder facing the crankcase up to the transfer port.

4. The two-stroke engine according to claim 2, wherein the cylinder liner has a circumferential wall provided with at least one channel in which the transfer passage extends, wherein the channel forms at least one sidewall of the transfer passage.

5. The two-stroke engine according to claim 2, wherein a section of the transfer passage is formed by a depression in an inner wall of the cylinder, wherein the depression has an end facing the combustion chamber and the end forms the transfer port.

6. The two-stroke engine according to claim 2, wherein the cylinder liner comprises a sleeve body and a sleeve segment that has a diameter smaller than a diameter of the sleeve body, wherein sleeve segment closes the at least one depression in a radial inward direction of the cylinder.

7. The two-stroke engine according to claim 2, wherein the cylinder liner has at least one depression that is closed completely by the cylinder.

8. The two-stroke engine according to claim 2, wherein the cylinder liner is a pressure die cast part, wherein the circumferential wall of the cylinder liner is fine-machined and wherein the cylinder liner is pressed into a bore of the cylinder.

9. The two-stroke engine according to claim 2, wherein the cylinder has a step and wherein the cylinder liner has a shoulder that rests against the step.

10. The two-stroke engine according to claim 1, comprising at least one insert that delimits at least one section of a side wall of a transfer passage.

11. The two-stroke engine according to claim 10, wherein the at least one insert delimits a part of the transfer passage adjoining the opening into the crankcase.

12. The two-stroke engine according to claim 11, wherein the part of the transfer passage is delimited entirely by the at least one insert.

13. The two-stroke engine according to claim 1, wherein the cylinder comprises at least one lid that delimits at least two of the transfer passages positioned adjacent to each other in an outward direction of the cylinder, wherein the transfer passages at the level of the lid are combined to a common channel.

14. The two-stroke engine according to claim 1, wherein the transfer passages extend at least partially at a slanted relative to a longitudinal cylinder axis of the cylinder.

15. The two-stroke engine according to claim 1, wherein at least two of the transfer passages have a common channel where the transfer passage are guided together, wherein the common channel is provided at an end of the transfer passages connected to the crankcase.

16. The two-stroke engine according to claim 1, wherein the opening at the crankcase of at least one of the transfer passages is arranged below the outlet.
